(19) United States
(12) Patent Application Publication
(10) Pub. No.: US 2015/0209678 A1
(43) Pub. Date: Jul. 30, 2015

(54) Gaming Platform System and Method for Interactive Participation by Players with Successes and Losses Transacted Using Bitcoin

(71) Applicant: LEETCOIN INC., Las Vegas, NV (US)

(72) Inventors: Kingsley EDWARDS, Las Vegas, NV (US); Edward COLMAR, Silver City, NM (US)

(21) Appl. No.: 14/611,036

(22) Filed: Jan. 30, 2015

Related U.S. Application Data
(60) Provisional application No. 61/933,505, filed on Jan. 30, 2014.

(51) Int. Cl. A63F 13/792; A63F 13/35

(52) U.S. Cl. CPC A63F 13/792; A63F 13/35

(57) ABSTRACT

A system and method is disclosed that is directed to a gaming platform that is adaptable for integration with existing competitive skill-based gaming system that will permit participating players to transact wins and losses in Bitcoin.

### CROSS-REFERENCE TO RELATED APPLICATIONS

This application claims priority under 35 U.S.C. §119(e) to U.S. Provisional Application Ser. No. 61/933,505 filed on Jan. 30, 2014, which is hereby incorporated by reference herein in its entirety.

### FIELD OF THE INVENTION

The present invention relates to systems and methods directed to gaming platforms. More specifically, the present invention relates to systems and methods directed to gaming platforms that involve player-to-player interaction and involve the wagering of funds on each players proficiency and skill in gameplay.

### BACKGROUND OF THE INVENTION

In present-day gaming, there are a variety of game genres. Examples of some of the genres that would be particularly applicable to the present invention are the following:

Ball and Paddle: This was the first game implemented on a home console, e.g., Pong. This could be played one player against the other.

Traditional Fighting Game: These games emphasize one-on-one combat between two characters, one of which may be computer controlled or controlled by another player.

Mascot Fighting Game: These games are often called “party brawlers.” Unlike traditional fighting games, mascot fighting games allow for up to four characters on the screen at a given time, up to three of which may be computer controlled. These games provide for player-to-player combat in gameplay. A feature of mascot fighting games is the ability for items to spawn on stage, giving a lesser skilled players assistance against tougher opponents.

Multiplayer Online Battle Area (“MOBA”): MOBA, also known as action real-time strategy (“ARTS”), is a subgenre of the real-time strategy (“RTS”) genre, in which two teams of players compete with each other in discrete games, with each player controlling a single character through an RTS-style interface. It differs from traditional RTS games in that there is no unit construction and players control just one character. This genre emphasizes cooperative team play.

Shooter Games: A Shooter game primarily focuses on combat involving weapons, such as guns and missiles. The various Shooter Games will now be discussed.

First-Person Shooter (“FPS”): FPS games emphasize shooting and combat from the perspective of the character controlled by the player. This perspective is meant to give the player the feeling of “being there,” and allows the player to focus on aiming.

Massively Multiplayer First-Person Shooter Games (“MMOFPS”): MMOFPS are a genre that combines FPS gameplay with a virtual world in which a large number of players can interact over the Internet. While standard FPS games limit the number of players able to compete in a multiplayer match, hundreds of players can battle each other on the same server in an MMOFPS.

Tactical Shooter Games: Tactical Shooter games are variations on the FPS genre. This genre focuses on realism and emphasizes tactical play, such as planning and teamwork. In multi-player modes, players must work in teams to win the game. Winning is likely to be dependent on capturing an objective of some sort rather than gaining the most kills.

Rail Shooter Games: Rail Shooter games are a subgenre of FPS in which the player's navigation through the game environment that is not under their explicit control. A rail shooter restricts the player's interactions to the tactical objectives in each scene and progresses between scenes by moving the player's camera into specific positions along the game map.

Third-Person Shooter Games: Third-Person Shooter games, known as TPSs or 3PSs, emphasize shooting and combat from a camera perspective in which the player character is seen at a distance. This perspective gives the player a wider view of their surroundings as opposed to the limited viewpoint of first-person shooters.

Role-Playing Games: Role-Playing games, also known as RPGs, typically cast the player in the role of one or more “adventurers” who specialize in specific skill sets, such as melee combat or casting magic spells, while progressing through a predetermined storyline. Many games of this genre involve maneuvering these characters through an overworld, usually populated with monsters, that allows access to more important game locations, such as towns, dungeons, and castles.

Western RPGs and Japanese RPGs (JRPGs): Because of cultural differences in RPGs, these games tend towards two sets of characteristics sometimes referred to as Western and Japanese RPGs (also referred to as “JRPG” or “JRPGs”). Western RPGs often involve the player creating a character and a nonlinear storyline along which the player makes his/her own decisions. In contrast, the second type, JRPGs, involves the player controlling a group of predefined characters through a dramatically scripted storyline.

Massively Multiplayer Online Role-Playing Games (“MMORPGs”): MMORPGs feature the usual RPG objectives of completing quests and strengthening one's player character, but involve up to hundreds of players interacting with each other in the same persistent world in real-time.

Tactical RPGs: This genre of games incorporates gameplay from strategy games as an alternative to traditional RPG systems. Like standard RPGs, the player controls a finite group and battles a similar number of enemies, but this genre incorporates strategic gameplay, such as tactical movement on an isometric grid.

Racing Games: These games place the player in the driver's seat of a high-performance vehicle and require the player to race against other drivers or sometimes just time.

Vehicular Combat Games: Vehicular combat or car combat games involve a player operating a car or other vehicle and attempting to disable or destroy CPU or human opponents. Vehicular combat games often allow a player to choose from a variety of potential vehicles, each with their own strengths and weaknesses.

Strategy Games: This genre of game focuses on gameplay requiring careful and skillful thinking and planning in order to achieve victory and the action scales from world domination to squad-based tactics.

Real-Time Tactics Game: Real-Time Tactics games often feature an overarching “campaign map” with different regions the player must vie for control of not dissimilar to the board game Risk. Base building in the traditional sense is usually relegated to building up the infrastructure of regions you own.

Sports Games: These games involve competitive play by one team, containing or controlled by you, and another team that opposes you. This opposing team(s) can be controlled by other real life people or artificial intelligence.

Competitive Games: These are games that have a high competitive factor but do not represent any traditional sports or the concept is fictional designed by the developer, e.g. ball jacks.

Massively multiplayer Online Game (“MMOGs”): A MMOG is a multiplayer game that is capable of supporting large numbers of players simultaneously. It is typically played on the Internet, MMOGs can enable players to cooperate and compete with each other on a large scale, and sometimes to interact meaningfully with people around the world.

The list of game genres provided above is not meant to be exhaustive of all that may have applicability to the present invention. The game genres that have been discussed briefly above have a common feature in which there is or may be competition between two game players and not just one game player against a CPU.

The winner of these games is typically decided based on the skill of the participants. That is, as the game players become more skilled and proficient in gameplay, their ability to win the game is increased. In some cases, as game players become more skilled and proficient, they will ascend to higher levels of gameplay with other equally or more skilled players, which keeps the game interesting to these game players.

When game players seek to match their skills and proficiency in a particular game against other game players, there is often a desire to include wagering as to a player's game playing ability. This is distinguished from games of chance where winning is not primarily based on game playing skill and proficiency.

In situations where there is wagering, there is great difficulty in carrying out the monetary transactions between winners and losers. This is not a difficult problem if, for example, the two players or groups of players are located in the same general area and payoffs can be effected by the physical transfer of the wagered funds from the losers to the winners. This is also not difficult if it could be established that the winners and losers use the same currency or are transacting through the same financial institution. This becomes extremely difficult when there may be cross-border wagering through a variety of transactional institutions and foreign-exchange issues exist.

There is a need for a system and method that would simplify effecting the ability for wagering game players to transfer funds from winners to losers so that the maximum amount of the wager may be transferred. Further, there is a need for a system and method that would securely transfer wagered funds from losers to winners particularly where different financial institutions are involved and the payments are being made cross-border.

The system and method the present invention overcome the problems of previous systems as will be set forth in the remainder of the specification referring to the drawings.

### SUMMARY THE INVENTION

The system and method of the present invention is directed to a gaming platform that is adaptable for integration with existing competitive skill-based gaming systems that will permit participating players to transact wins and losses in a crypto-currency, such as Bitcoin.

According to the system and method the present invention, an existing gaming system would have the present invention layered on top of it. The system and method the present invention may be implemented in an application program interface (“API”) server disposed between system users and an existing gaming system. In such a configuration, system users preferably access the API server containing the system and method the present invention from their input devices, which include smart phones, personal digital assistants (“PDA”), tablets, laptop computers, or desktop computers.

When the system user accesses the API server in anticipation of playing a game against competitors, the system user must ensure that his/her electronic Bitcoin account contains adequate funds to play the game against a competitor so that the system user's wins and losses can be reconciled from the standpoint of the transfer of bitcoins to and from that account based on wins and losses. Therefore, when a system user wins against a competitor during gameplay, a certain amount of bitcoins will be transferred from the losing competitor's Bitcoin account to the system user's Bitcoin account and if the system user loses to a competitor during gameplay, a certain amount of bitcoins will be transferred from the system user's Bitcoin account to the winning competitor's Bitcoin account.

The system and method the present invention provide a plurality of ways by which a system user can prepare and play an existing game with the API server layered on top of the game server. Before engaging in gameplay at which the system user places bitcoins at risk, the system user can play against the game server to understand transacting the bitcoin in gameplay. In actual gameplay, when bitcoins may be transacted between winners and losers, the system user also has ways by which he/she can earn additional Bitcoins. This provides a method by which the system user can enhance the number bitcoins in his/her Bitcoin account without the need of the risk of gameplay.

The use of bitcoins for transacting wins and losses in gameplay provides a mechanism by which the players are given a more exacting way by which to carry out these transactions across country and monetary borders with a minimum amount of loss due to things like the rate of foreign exchange. This results in a monetary standard by which gameplay transactions can take place whether the players are within the same monetary jurisdiction or in different monetary jurisdictions. As such, whether the game is played on a strictly player versus player basis or a massively multiplayer basis, the monetary transactions that are being carried out as a result of gameplay will all be transacted on the Bitcoin basis, and, therefore, all players are on an even transacting basis.

The system and method the present invention will be described in greater detail in the remainder of the specification referring to the drawings.

### BRIEF DESCRIPTION OF THE DRAWINGS

FIG. 1 shows a representative drawing of a prior art gaming system.

FIG. 2 shows a representative drawing of the system and method of the present invention layered on top of an existing gaming system.

FIG. 3 shows a representative drawing of the gameplay configuration for system users to interact in competitive gameplay.

FIG. 4 shows a representative drawing of the communications that takes place between the API server and the game server.

FIG. 5 shows a representative high-level drawing of the system and method of the present invention shown in FIG. 3 for purposes of demonstrating transacting wins and losses in Bitcoin during gameplay.

FIG. 6 shows a representative Profile screen display for a system user, e.g., system user “neg0.”

FIG. 7 shows a representative Transactions screen display for Bitcoin transactions that have taken place with respect to system user neg0 and the impact the transactions have on the system user's Bitcoin account.

FIG. 8 shows a representative History screen display showing the history of matches associated with system user neg0.

FIG. 9 shows a representative Deposit screen display that a system user will use for purpose of making bitcoin deposits into his/her Bitcoin account.

FIG. 10 shows a representative Withdraw screen display that a system use will use for the purpose of making a bitcoin withdrawal from his/her Bitcoin account.

FIG. 11 shows a representative screen display of a server page on which a system user may seek to register onto a particular gameplay server.

FIG. 12 shows a representative screen display a system user will use to register on a game server through the API server.

FIG. 13 shows a representative screen display a system user will use to unregister from a game server through the API server.

FIG. 14 shows a representative screen display that a system user will use for creating a match with another system user to transact wins and losses using bitcoins.

FIG. 15 shows a representative screen display that a system user will see after creating a match according to what is shown in FIG. 14.

FIG. 16 shows a representative screen display showing a match a system user will see for competitive gameplay with another system user in which wins and losses will be transacted using Bitcoin.

FIGS. 17-20 show a representative set of screen displays depicting gameplay and the changing balances in bitcoins based on wins and losses of the competing system users.

### DETAILED DESCRIPTION OF THE INVENTION

The system and method of the present invention is directed to a gaming platform that is adaptable for integration with existing competitive skill-based gaming system that will permit participating players to transact wins and losses in Bitcoin. For purposes of the present invention, Bitcoin is a digital currency, also referred to as crypto-currency, that is not backed by any country's central bank. Bitcoins can be traded for goods or services that would accept them as payment. A “Satoshi” is a division of a Bitcoin. 1 Satoshi equals 0.00000001 [symbol] and, conversely, 1 [symbol] equals 100,000,000 Satoshi. It is to be understood that the present invention is being described with respect to Bitcoin; however, other crypto-currencies may be used and it would still be within the scope of present invention.

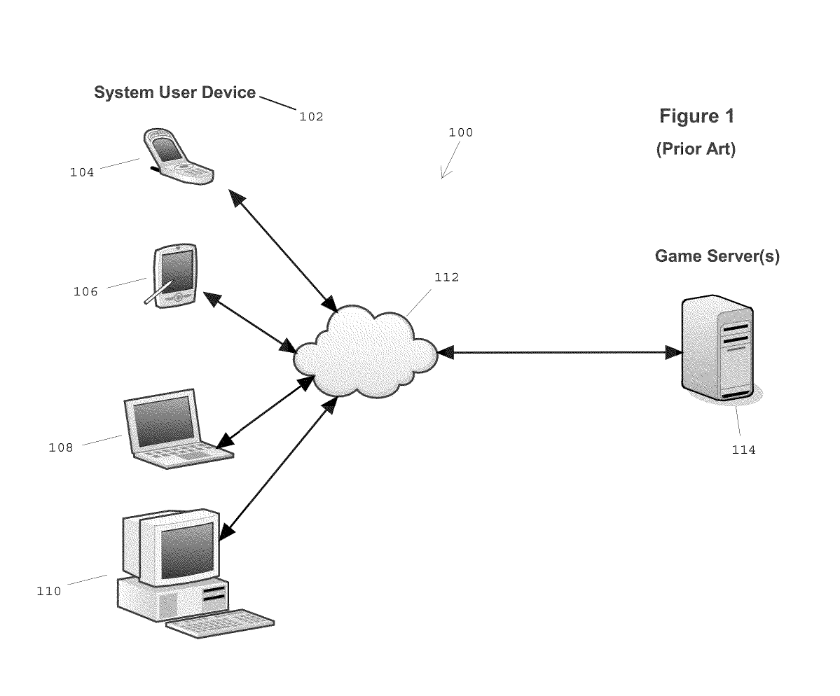

Prior to discussing the system and method the present invention, the conventional type of gaming platform will be discussed referring to FIG. 1. Referring to FIG. 1, generally at 100, representative system user devices are shown generally at 102. These devices include a smart phone at 104, PDA at 106, laptop at 108, and desktop computer at 110. It is understood that other than these types of input devices may be used by system users and it would still be within the scope of the present invention. The Figure only shows that four devices are connected to representative Internet cloud 112. However, it is understood that one or more of each these devices may be connected to the Internet cloud for purposes of participating in gameplay and it would still be within the scope of the present invention.

As shown, the system user devices at 102 connect to Internet cloud 112. The connection between the system user devices at 102 and Internet cloud 112 are bidirectional and wireless. Internet cloud 112 connects to one or more game servers 114. The connection between Internet cloud 112 and one or more game servers 114 is (are) bidirectional and wired or wireless.

The game server at 114 is meant to represent any of a number of game servers to which the system users may connect, e.g., Counter-Strike, Team Fortress 2, and Battlefield 3. Each game server may be directed to a specific game or there may be multiple servers associated with a single game. Each of these configurations is within the scope of the present invention. It is further understood that each game server may have a workstation connected to it for system administration by the game company offering the game.

In conventional competitive gameplay, for example, a first system user associated with laptop 108 and a second system user associated with desktop 110 may logon to a specific game being run by game server 114. Through a graphic user interface (“GUI”) to which each system user is associated, they will logon to the game according to its particular rules and engage in competitive gameplay in which one of the system users will be victorious over the other system user. This type of competitive gameplay may be in any of the game genres discussed previously as long as the genre permits such interactive gameplay. However, it is understood that skilled and proficient system users also may compete against the gameplay server. In such a case, the opponent will be the gameplay server rather than a live competitor.

At the end of the game, the victorious system user may be permitted to advance in game levels or receive some type of award within the game's rules. The system user that loses the game experiences just the knowledge of having lost but is not required to give up anything of personal value for the loss. With this type of scenario, some of the attractiveness of the game may be lost in a short period of time, particularly by those who increase their proficiency and skill level. When this happens, many go to another game.

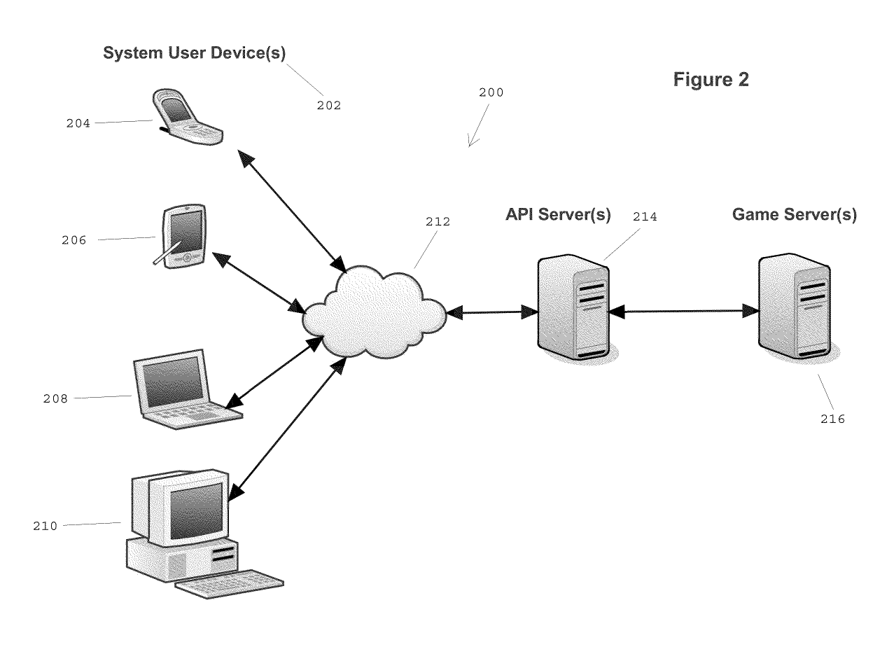

Referring to FIG. 2, the present invention will now be described as it is layered on top of an existing gameplay server. The layering the present invention on top of an existing gameplay platform applies to any game genre that will allow system users to pit their proficiency and skill in gameplay against other system users or against a CPU of the game server.

Again referring to FIG. 2, generally at 200, the system user devices are shown generally at 202. A representative smart phone device is shown at 204, a representative PDA is shown at 206, a representative laptop is shown at 208, and a representative desktop computer is shown at 210. As with the system user input devices shown in FIG. 1, it is understood that other than these types of input devices may be used by system users to participate in gameplay and it would still be within the scope of the present invention.

Each of the system user input devices wirelessly and bidirectionally connects to representative Internet cloud 212. It is understood that one or more of each these devices may be connected to the Internet cloud for purposes of participating in gameplay and still be within the scope of the present invention.

Internet cloud 112 wired or wirelessly connects to one or more API servers 214. The API servers 214 of the system and method the present invention layer on top of gameplay servers 216. With respect to the system users who interact in gameplay using system user devices 204 through Internet cloud 212, in conducting gameplay, it will appear that the functionality of the system and method the present invention is a fully integrated part of the game.

The layering of the system and method the present invention through API server 214 will permit the system users through their input devices at 204, 206, 208, and 210 to interact with other system users in competitive gameplay and be rewarded for their proficiency and skill in bitcoins.

Similar to FIG. 1, game servers at 216 are meant to represent any number of game servers to which the system users may connect. Each game server may be directed to a specific game or there may be multiple servers associated with a single game. Each of these configurations is within the scope of the present invention.

It is understood that there may be one or more API servers associated with any one game server or one API associated with one or more game servers associated with a single game. Further, each API server may have a workstation connected to it for the purpose of system administration. Likewise, each game server may have a workstation connected to it for the purpose of system administration.

It would be understood by a person of ordinary skill in the art that the API server and game server may include a CPU, internal memory, input/output (“I/O”) systems, and connections between these elements and it would be within the scope of the present invention. It would be also understood by a person of ordinary skill in the art that and external memory, e.g. an external database memory, may be connected to either the API server or game server and it would be within the scope of the present invention.

In competitive gameplay using the gaming platform that includes the system and method of the present invention, each system user interested in competitive gameplay in which wins and losses will be transacted in Bitcoin will logon using the GUI of that system user's device, such as those shown at 202 in FIG. 2. Through the GUI, the system user will make Bitcoin deposits, specify the game server on which he/she desires to enter into competitive gameplay, and then play the selected game. If this is the system user's first time entering into competitive gameplay using bitcoins to transact wins and losses, the system user must first acquire bitcoins before selecting a game server and beginning competitive gameplay. To do this, the system user will register on the appropriate API server, acquire bitcoin, and set up a Bitcoin account. After this, system user may select a game server and begin competitive gameplay. This general description will be described in greater detail subsequently in the specification.

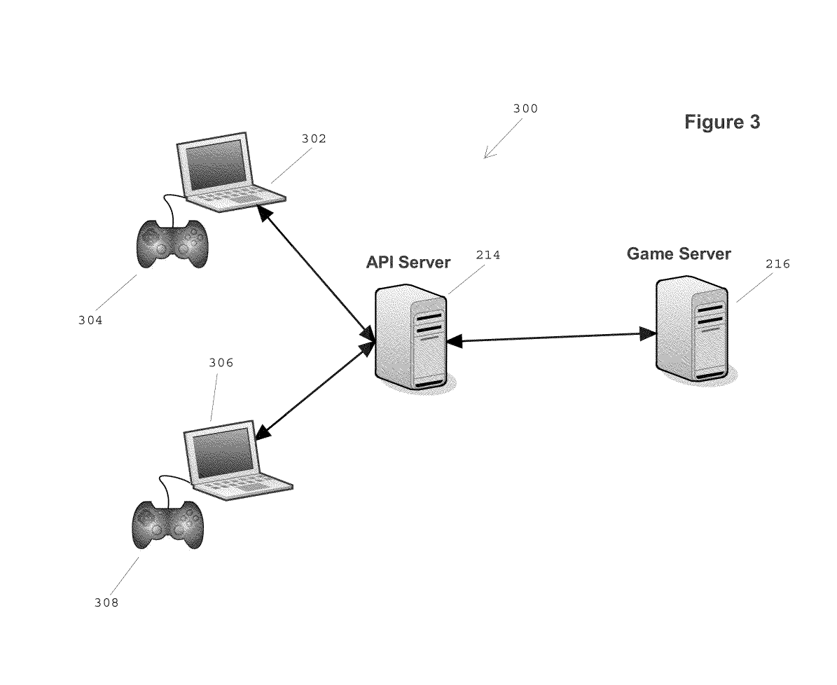

Referring to FIG. 3, generally 300, the configuration of a platform system in which the system and method the present invention is integrated for gameplay is shown. For purposes of illustration only, the Internet cloud is not shown in FIG. 3. However, a person of ordinary skill in the art would easily understand the inclusion of such an Internet cloud in this Figure.

According to this Figure, a first system user would interact with API server 214 and game server 216 using laptop 302, which may have connected to it game controller 304. It would be understood by a person of ordinary skill in the art that the first system user may carry out gameplay using controller 304 that is connected to laptop 302 or use the keys of laptop 302 and it would still be within the scope of the present invention.

Similarly, a second system user would interact with API server 214 and game server 216 using laptop 306, which may have connected to it game controller 308. It would be understood by a person of ordinary skill in the art that the second system user may carry out gameplay using controller 308 that is connected to laptop 306 or use the keys of laptop 306 and it will still be within the scope of the present invention.

The system method the present invention that is layered on top of an existing game system accommodates the proficiency and skill of gamers at all skill levels. The system and method of the present invention also seeks to accommodate first time players who have not acquired bitcoins and seek to learn about the use of the system and method the present invention in gameplay before taking any financial risks in such competitive gameplay. This is accomplished by permitting first time users to connect to specific game servers, promo servers, that provide limited play and that player can play for free against the promo server that is part of game server.

Once the system user believes that he/she has gained enough information/experience regarding gameplay using the system and method the present invention that involves transacting in Bitcoin, that system user will then enter competitive gameplay. In order to do this, the system user must establish an electronic account and load bitcoins into that account sufficient to meet the gameplay requirements. After this, the system user can begin gameplay and wins and losses will be transacted in bitcoins. At the conclusion of gameplay, the system user will have the balance of bitcoins in his/her electronic Bitcoin account reflect the successes and losses experienced on gameplay. Now that the general description of gameplay using the system and method the present invention has been provided, a more in-depth discussion of the present invention will be provided.

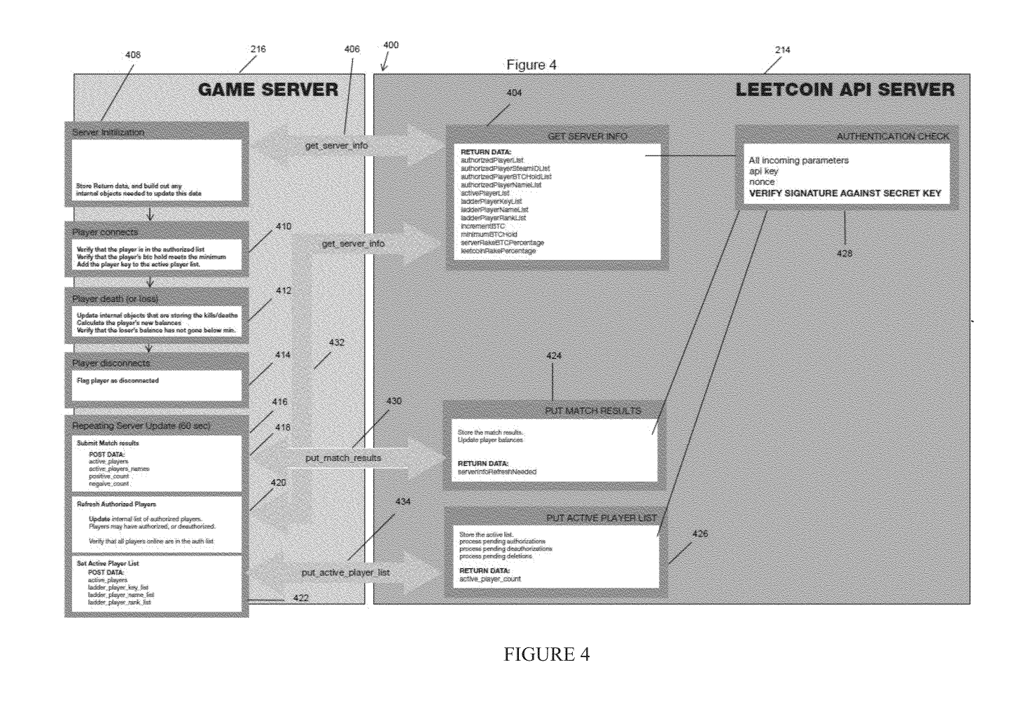

FIGS. 3 and 4 show that the system users access the API server the present invention and the API server connects the system user to the game server for conducting gameplay. Referring to FIG. 4, the interaction between API server 214 and game server 216 will be described.

Taking, for example, the situation when there is to be competitive play between two system users in which wins and losses will be transacted in Bitcoin, each system user will engage in the logon and identification process with respect to API server 214. There will then be an exchange of information between API server 214 and game server 216, which will be described referring to FIG. 4.

Referring to FIG. 4, generally at 400, the interaction of API server 214 and game server 216 will be described. Given the assumption that each of the system users who desire to compete in a competitive game in which wins and losses will be transacted in Bitcoin, each of these system users will have selected the same game server with which to display their proficiency and skill in gameplay. Based on the request for gameplay that each the system users provided to API server 214, there will be a request to initialize the game server sent from API server 214 to game server 216. This request may be sent via a connection, such as connection 406. The result is that there is a transmission of return data shown at 404 from API server 214 to the server initialization at 408 of game server 216. Server initialization at 408 stores the return data sent from 404 of API server 214 on game server 216 and the game server will build out any internal objects needed to update this data. In this case, “build out” means that the internal structures can be configured so that the system user can be notified during gameplay of what his/her real time Bitcoin balance is on a particular game server.

The return data at 404 of API server 214 that is transmitted to game server 216 includes:
A. Authorized player list (“authorizedPlayerList”): This is the list of authorized players according to the API server who can transact gameplay in Bitcoin.
B. Authorized player ID list (“authorizedPlayerSteamIDList”): This is the list of IDs for all of the authorized players according to the API server who can transact gameplay in Bitcoin.
C. Authorized player Bitcoin hold list (“authorizedPlayerBTCHoldList”): This is the list of the crypto-currency sum of the authorized/registered system user deposits on a game server.
D. Authorized player name list (“authorizedPlayerNameList”): This is the list of the system user names who are authorized players according to the API server who can transact gameplay in Bitcoin.
E. Active player list (“activePlayerList”): This is a list of all of the players who are active in a game according to the API server who can transact gameplay in Bitcoin.
F. Ladder player key list (“ladderPlayerKeyList”): This is a list of assigned player keys (serial numbers) for each system user on a game server.
G. Ladder player name list (“ladderPlayerNameList”): This is a list of assigned nicknames for each individual system user on a game server.
H. Ladder player rank list (“ladderPlayerRankList”): This is a list of ranks that each individual system user has on a given game server.
I. Increment Bitcoin (“incrementBTC”): This represents the value that each gameplay objective credits or debits the system user's balance on a game server.
J. Minimum Bitcoin hold (“minimumBTCHold”): This represents the minimum amount of Bitcoin a player must hold in his/her Bitcoin account to participate in gameplay.
K. Server rake Bitcoin percentage (“serverRakeBTCPercentate”): This represents the percentage that each game server takes from a system user's game server balance after the system user is awarded for completing a game play objective.
L. LeetCoin rake percentage (“leetcoinRakePercentage”): This represents the percentage a API server administrator takes from a system user's game server balance after the system user is awarded for completing a game play objective.

A person of ordinary skill in the art would understand that more or less than the return data shown above may be transmitted from API server 214 to game server 216 and it would still be within the scope of the present invention.

After game server 216 is initialized at 408, the system users who are going to compete to transact wins and losses in Bitcoin will be connected to the game server for gameplay through API server 214. The connection of the system users to the game server is shown at 410. At 410, based on the return data game server 216 received from API server 214, the game server will verify that the system user seeking to enter gameplay is an authorized player. This will involve verifying that the following return data items are correct. The system user ID, e.g., steamID, and the playerkey. Further, game server 216 will verify that the amount of bitcoins the system user has held meets a minimum requirement before the system user will be allowed to enter gameplay. The return data that the game server reviews for this purpose includes the minimum Bitcoin value being held. If the system user is verified at each of these tests, that system user's player key is added to the active player list for gameplay.

After gameplay starts, game server 214 on a predetermined periodic basis will update a number of gameplay values at 412. As shown at 412, internal database files are for storing, for example, the number of “Kills” obtained by each system user and the number of “Deaths” sustained by each system user. These numbers are used to calculate new Bitcoin balances for each system user during and at the end of gameplay. When these calculations are made, game server 216 will verify that the losing system user's Bitcoin balance does not go below the minimum that was specified to be held in the return data at 404 in API server 214. If a system user's Bitcoin balance goes below the minimum, that system user must replenish the Bitcoin amount held for the gameplay before that system user can continue gameplay. If this is not done, the system user will be disconnected from gameplay. If a system user disconnects from gameplay, game server 216 sets a flag for that system user at 414 to show that the player is no longer active in the game.

It is to be noted that the numeric values being recorded above are for “Kills” by a system user or “Deaths” sustained a system user. “Kills” and “Death” are used only for the purpose of an example of what may be recorded for purposes of transacting in Bitcoin for gameplay. It would be understood by a person of ordinary skill in the art that other types of values may be kept for purposes of transacting in Bitcoin for gameplay and it still would be in the scope of the present invention. It is further understood that items being verified by the game server for purposes of determining whether a player is qualified to enter gameplay may be more or less than what is been shown and described with respect to 410 and it would still be within the scope of the present invention.

As indicated above at 412 of game server 216, there is a periodic update of information during gameplay. At 416, there is representative information that is periodically updated during the course of gameplay. For purposes of example only, these updates take place every 60 seconds. However, it would be understood by a person of ordinary skill in the art that such updates may take place at time periods more or less than 60 seconds and it would still be within the scope of the present invention.

As shown at 418, match results from gameplay are updated every 60 seconds. These results are transmitted from game server 216 to API server 214 using connection 430. At API server 214, match results are input to 424 where the match results are stored in a system database associated with API server 214. In storing the results in such database, each of the active system user's Bitcoin account balance is updated. Further, at 424 of API server 214, with respect to return data, there is a server information refresh need (“serviceinfoRefreshNeeded”) message generated. This message is for an updated balance from the game server and it is sent to the API server to cause an update to a system user's balance to take place.

Returning to 418 in game server 216, match results data that is posted to API server 214 every 60 seconds includes the number of active players (“active_players”) participating in matches, the names of the active players (“active_players_names”) in matches, the positive count (“positive_count”) of “Kills” for each active player in matches, and the negative count (“negative_count”) of “Deaths” for each active player in matches. It would be understood by a person of ordinary skill in the art that more or less than the four items shown at 418 may be transmitted to API server 214 and it would still be within the scope of the present invention.

Game server 216 updates that take place every 60 seconds include a refresh of the authorized system users. As indicated above, part of the return data transmitted from 404 of API server 214 to server initialization at 408 includes the authorized player list. This will cause game server 216 to generate its own internal list of authorized system users. The authorized players must fulfill all the system requirements for participating in gameplay including having the minimum amount of bitcoins held for gameplay. If during gameplay, a system user no longer has that amount of bitcoins then that system user would no longer be an authorized player and would be determined to be deauthorized. It is understood that deauthorizing a system user may involve situations other than such a system user not having the appropriate amount of bitcoins held and it would still be within the scope of the present invention.

During the refresh of authorized players at 420, the game server verifies that all the players participating in gameplay for on the authorized list. This information is transmitted over connection 432 to update return data information at 404 of API server 214.

Game server 216 at 422 also updates the active player list during the updates taking place every 60 seconds. The active player list information that is updated includes the active players (“active_players”) participating in gameplay, the ladder player key list (“ladder_player_key_list”) for the active players in gameplay, the names of the system users according to the ladder player list (“ladder_player_name_list”), and ladder player rank list (“ladder_player_rank_list”). It would be understood by a person of ordinary skill in the art that more or less than the four items shown at 422 may be transmitted to API server 214 and it would still be within the scope of the present invention.

The active player list information at 422 is transmitted via connection 434 to 426 of API server 214. The API server will use the information in a plurality of ways. The API server will store the active list of players in the system database. This information will also be used to update the return data. API server 214 also processes the pending authorizations, pending deauthorizations, and pending deletions of system users based on this information. In this case, “deletions” refers to updating the active authorized player list to account for system users that have unregistered from the game server.

API server 214 also carries out an authorization check at 428 for activities taking place at 404, 424, and 426. This authorization check is directed to all incoming parameters from the game server; the API key, which refers to a code passed in by the API server to identify the calling program, its developer, or a system user to the website; and the nonce, which refers to a one-time check to verify a system user's registration status on the game server. In carrying out the authorization check, there is a verification of the API key signature against a secret key. The secret key is used to verify the API key. The authorization checks are specifically carried out as follows with respect to 404, 424, and 426 of API server 214.

Before discussing the display screens presented to system users for gameplay using the system and method of the present invention, a high level example will be described for two competing system users to carry out gameplay and transacting wins and losses using Bitcoin.

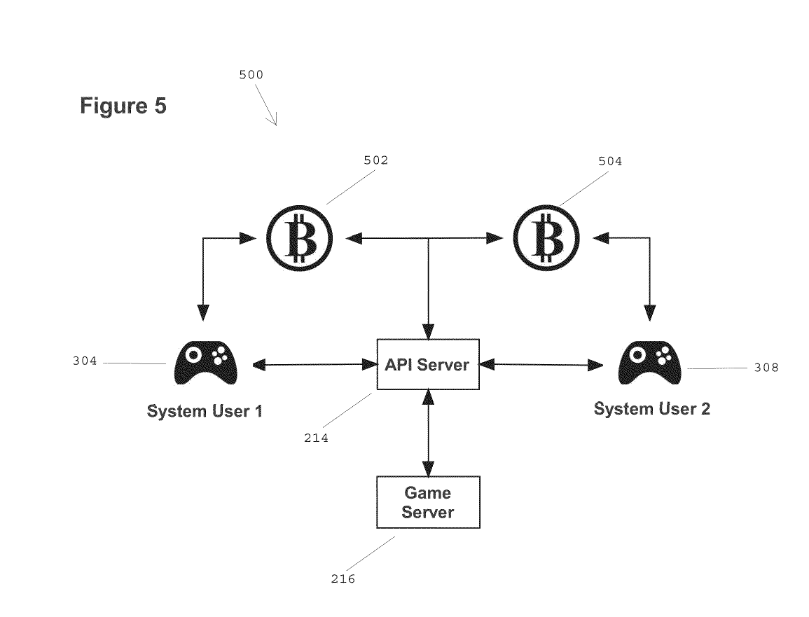

Referring to FIG. 5, generally at 500, the configuration of the gaming platform incorporating system and method of the present invention is shown. As shown in FIG. 5, game controller 304 is associated with system user 1 and game controller 308 is associated with system user 2. The game controllers are representative of any device that may be used for permitting the system user to conduct gameplay. Therefore, a smart phone, tablet device, PDA, laptop, or desktop would be considered game controllers for purposes of the present invention.

In FIG. 5, game controller 304 and game controller 308 connect to API server 214. API server 214 connects to game server 216. As such, each of the system users using their respective game controller can carry out gameplay through API server 214, which will track user wins and losses for purposes of transacting in Bitcoin for gameplay and interacting with game server 216 to conduct gameplay.

As shown in FIG. 5, there is Bitcoin symbol 502 between API server 214 and system user 1 game controller 304 and Bitcoin symbol 500 for between API server 214 and system user 2 game controller 308. The symbols are placed at these locations to show each system user's Bitcoin account. For example, if during gameplay, system user 1 using game controller 304 effects a “Kill” against system user 2 using game controller 308, 0.01 BTC is transferred instantly from system user 2's Bitcoin account at 504 to system user 1's Bitcoin account at 502. Depending on the system, the API server may charge a transaction fee for carrying out transactions with respect to making transfers between winners and losers either on a per transaction basis or group or batch basis.

Now, the system user Profile will be described followed by the method by which bitcoins are deposited and withdrawn from the system users' Bitcoin accounts.

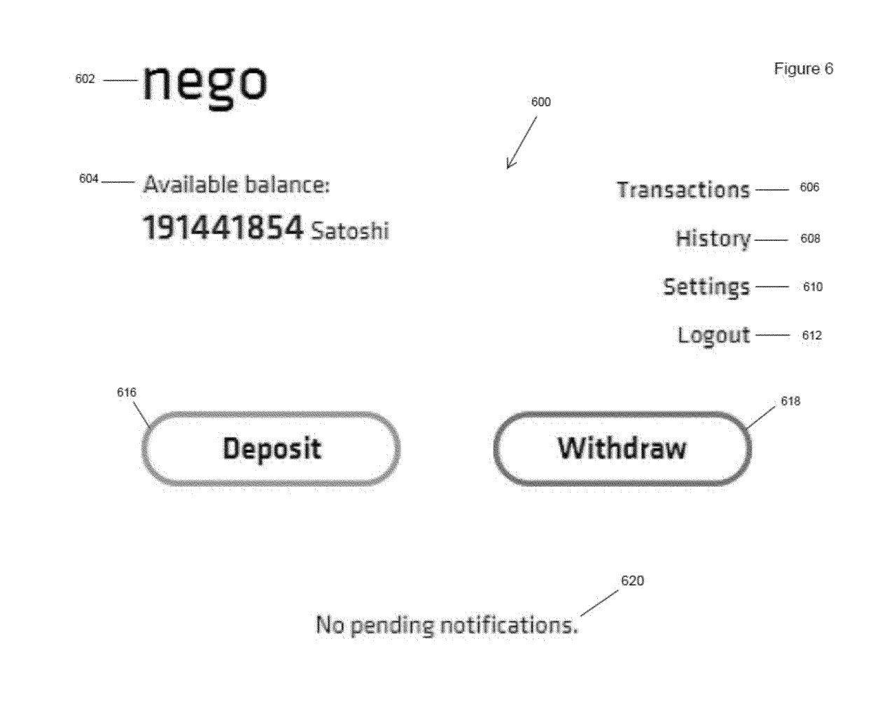

Referring to FIG. 6, generally at 600, a representative “Profile” display screen is shown for a system user, which in this case is system user “neg0.” This Profile is for a system user who has already logged onto API server 214 and through which can enter gameplay on game server 216 to transact wins and losses in Bitcoin.

Again referring to FIG. 6, according to the Profile display screen, the system user's name, neg0, is shown at 602. Neg0's available balance of Satoshi is shown at 604. This amount of Satoshi is what neg0 has available for competitive gameplay against other system users or the gameplay computer to transact wins and losses in bitcoins.

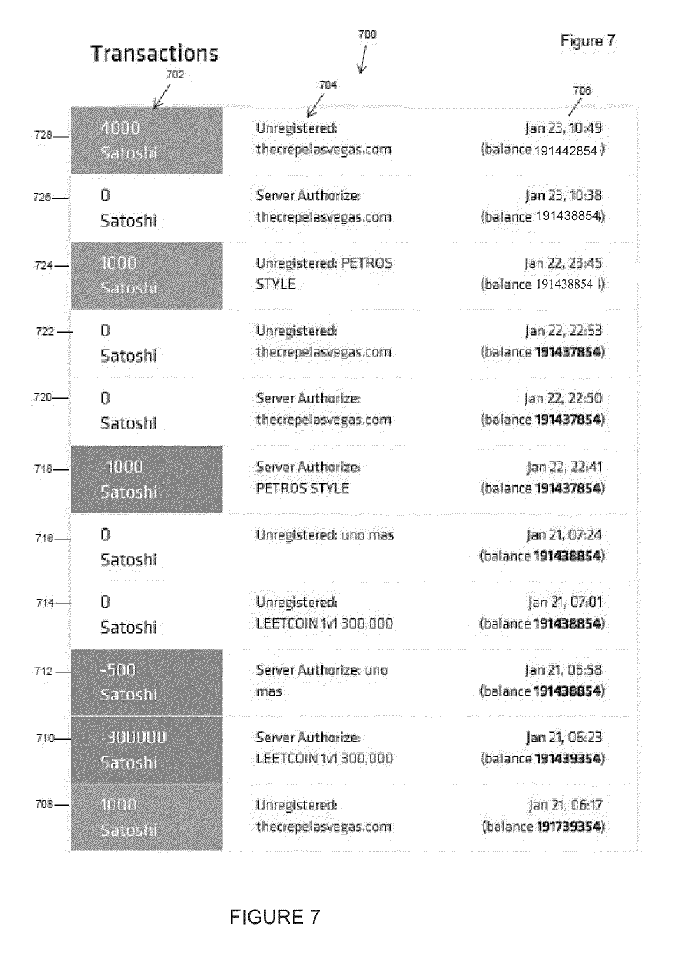

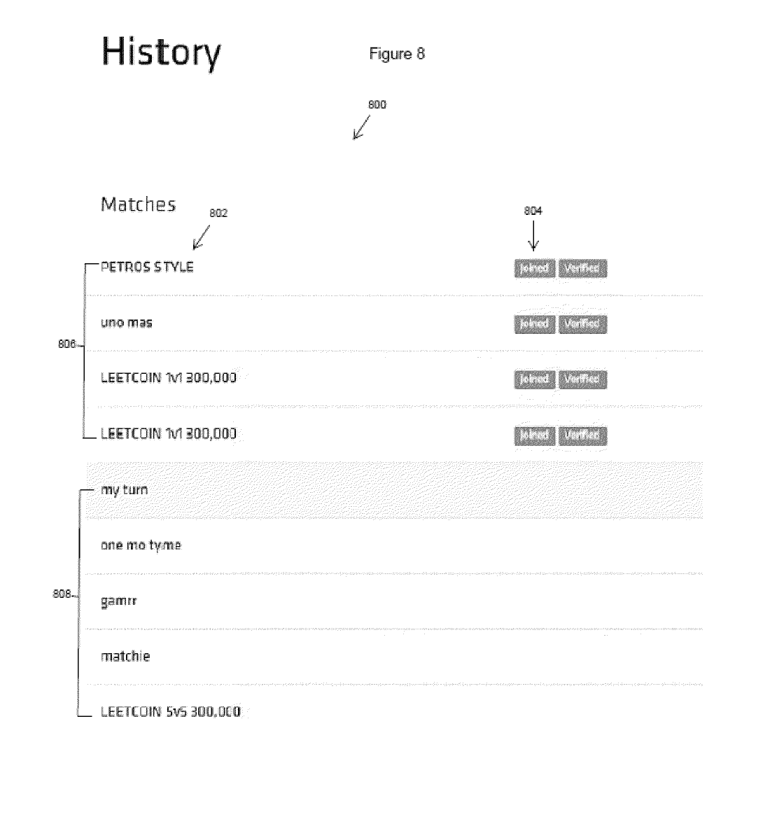

Profile display screen 600 includes Transactions icon 606, History icon 608, Settings icon 610, and Logout icon 612. The results of the activation of Transactions icon 606 will be described with respect to FIG. 7 and the activation of History icon 608 will be described with respect to FIG. 8. The activation of Setting icon 610 will provide a display screen that will include the option for the system user to change his/her nickname and view his/her player key. Further, activation of Logout icon 612 will cause the system user neg0 to log off of API server 214 and gameplay on game server 216.

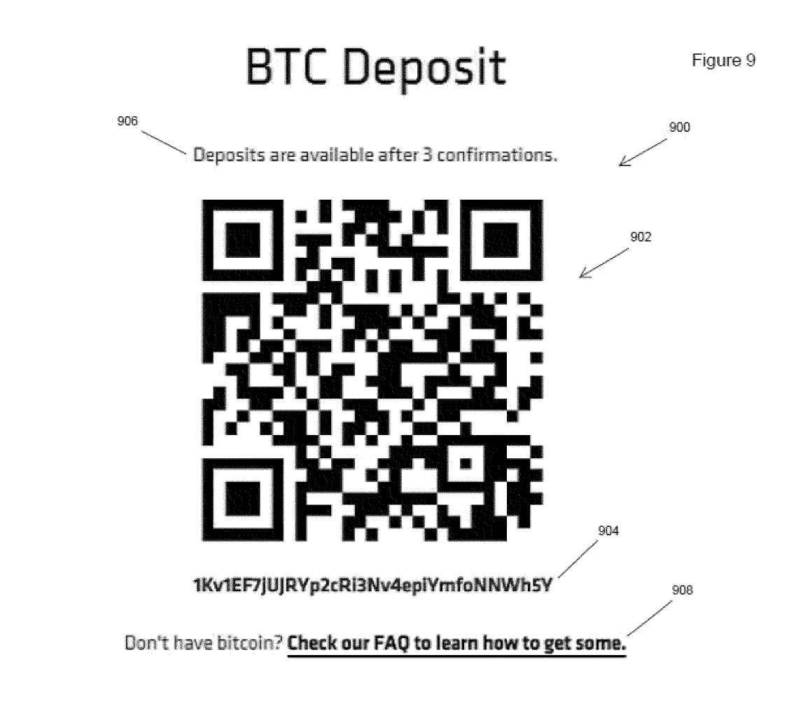

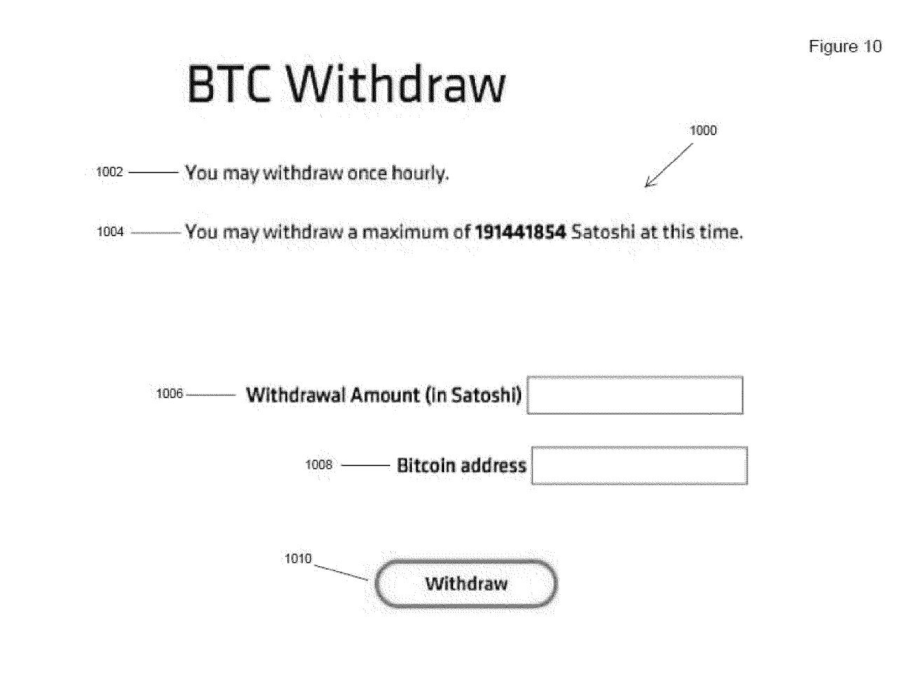

FIG. 6 shows Deposit icon 616 and Withdraw icon 618. Activation of Deposit icon 616 will be described with respect to FIG. 9 and activation of Withdraw icon 618 will be described with respect to FIG. 10.

On Profile screen display 600, there is an indication of “No pending Notifications” in notifications section 620. This notifications section may provide information such as matches played, game server registration status, and successful deposits and withdrawals.

Again referring to FIG. 6, if the system user neg0 activates Transactions icon 606, it will open the Transactions display screen shown in FIG. 7, generally at 700. This display screen shows each of the transactions in bitcoin that has taken place with respect to system user neg0. The transaction at the top of this display screen is the most reach in time. The three columns of the Transaction display screen show the amount of Satoshi in each transaction at 702; the action being taken and the gameplay server or otherwise with respect to where it was taken for each transaction at 704; and the time, date, ending balance of each transaction at 706.

Referring to row 708 of Transactions display screen 700, it shows that there was a transaction of +1000 Satoshi with respect to unregistering from the website “thecrepelasvegas.com” on Jan. 21, 2015, leaving an ending balance of 19739354 Satoshi in neg0's Bitcoin account. This activity is associated with gameplay. For example, a system user registered (authorized) on a promo (promotional) server with a “0” server balance and unregistered with a +1000 Satoshi balance by winning a round on the game server will have this reflected on his/her transaction display screen.

Referring to row 710 of Transactions display screen 700, it shows that there was a transaction of −300000 Satoshi that was authorized by API server 214 for gameplay match LEETCOIN 1v1 300,000. As is shown, this reduced neg0's Bitcoin account balance to 19439354 Satoshi.

Referring to row 712 of Transactions display screen 700, it shows that there was a transaction of −500 Satoshi that was authorized by API server 214 for gameplay match “uno mas,” which reduced the Bitcoin account balance to 19438854 Satoshi.

Row 714 and row 716 show where neg0 unregistered from the two gameplay matches LEETCOIN 1v1 300,000 and uno mas, respectively. Since this was a matter of unregistering from these matches, there was no Satoshi involved and, therefore, each of these transactions are shown as “0” Satoshi.

Row 718 of Transactions display screen 700 shows there was a transaction of −1000 Satoshi that was authorized by API server 214 for gameplay match PETROS STYLE. This reduced neg0's Bitcoin account balance to 19437854 Satoshi.

The next transaction at 720 shows the API server authorized a transaction of “0” Satoshi with respect to website “thecrepelasvegas.com.” Since the transaction was for “0” Satoshi there is no change in the Bitcoin account balance. The server authorization of this transaction is to indicate that the system user has registered on the game server. At row 722, it shows that neg0 unregistered from the website “thecrepelasvegas.com” that did not result in any change in the Bitcoin account balance because the transaction was for “0” Satoshi.

At row 724 of Transactions display screen 700, there is shown a transaction for +1000 Satoshi when neg0 unregistered from gameplay with respect to the PETROS STYLE match. The account balance will be increased to 19438854 Satoshi.

Referring to row 726 of Transactions display screen 700, the API server authorized a “0” Satoshi transaction with respect to website “thecrepelasvegas.com.” This transaction did not change the Bitcoin account balance. Like the transaction at row 720, this transaction is for registration of the system user on the game server.

The transaction at row 728 is for +4000 Satoshi. This transaction is for unregistering from website “thecrepelasvegas.com.” This transaction increased the Bitcoin account balance to 19442854 Satoshi.

Again referring to FIG. 6, if system user neg0 activates History icon 608, the display screen at FIG. 8 will be displayed. Referring to FIG. 8, generally at 800, the history of matches entered into by system user neg0 is shown. The column at 804 of display screen 800 shows the list of matches entered into by system user neg0 and column 804 shows the status of the system user with respect to such matches. For example, the first four matches shown at 806 indicate that system user neg0 “joined” those matches and was “verified” with respect to them. In referring to “verified,” it means that the matches were verified.

The matches shown at 808 of FIG. 8 do not have anything entered in column 804. This means that the matches never took place.

Referring to FIG. 6, if system user neg0 activates Deposit icon 616, the BCT Deposit display screen at FIG. 9 will be opened. FIG. 9, generally at 900, shows the information that is displayed for depositing bitcoins to the system user's Bitcoin account. What is shown at 902 and 904 is what is needed for the addition of bitcoin to the system user's account. As indicated at 906, deposits will be available to the system user in his/her Bitcoin account after three confirmations are made. Further, there is a link at 908 for the system users to learn how to obtain bitcoin for deposit in his/her Bitcoin account.

Again referring to FIG. 6, if system user neg0 activates Withdraw icon 618, the display screen shown in FIG. 10 will be opened. Referring to FIG. 10, generally at 1000, at 1002, it shows how often a system user may make a withdrawal from his/her Bitcoin account. This value may be changed to more or less than hourly and it would still be within the scope of the present invention.

As shown at 1004, there is a maximum of 19441854 Satoshi available to be withdrawn. This is consistent with the available balance of Satoshi on Profile dashboard display screen 600 in FIG. 6. At 1006, the system user will enter the amount of Satoshi he/she wants to withdraw from his/her Bitcoin account and, at 1008, the system used will enter the Bitcoin address to where he/she wants that amount of Satoshi transferred. Once these two values are entered, the system user will activate the Withdraw icon at 1010, which will affect the transfer. Depending on the amount to be withdrawn, the available balance of Satoshi on Profile dashboard display screen 600 in FIG. 6 will be appropriately reduced.

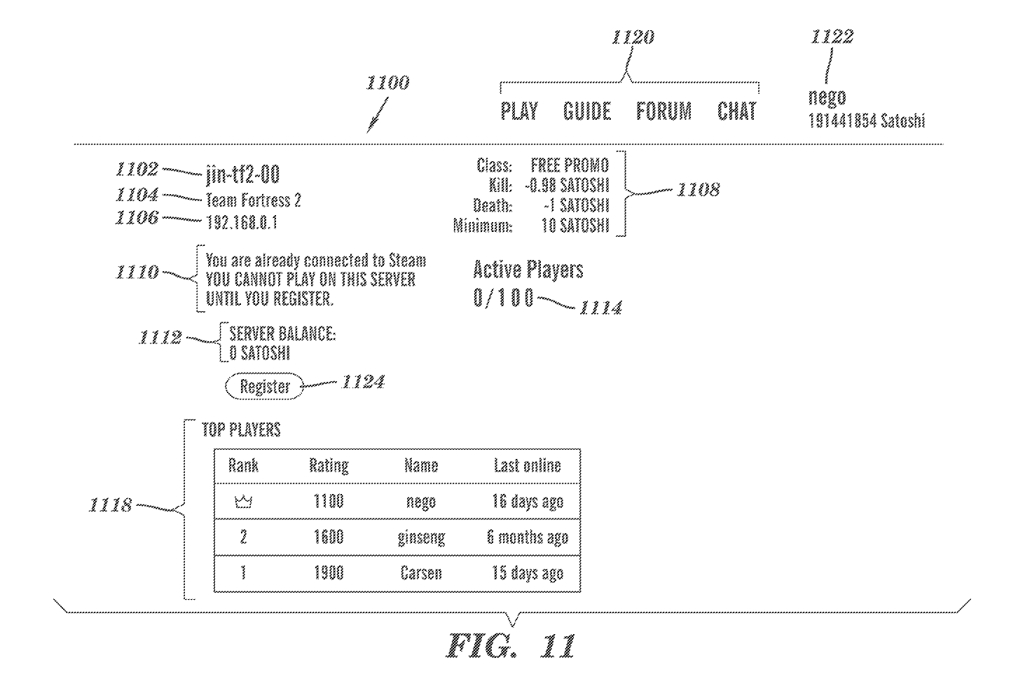

When a system user, such as neg0, desires to logon to a game server for gameplay and transact wins and losses in Bitcoin, the system user will logon to API server 214 and through the API server select a particular game server for which he/she seeks to engage in competitive gameplay with other system users or the game server itself. The display screen that will permit system users to select a game server includes the ability for the system user to register on the game server. In selecting the game server, which by way of example is “jin-tf2-00,” the screen display shown at FIG. 11 will be open.

Referring to FIG. 11, generally at 1100, the information relating to the game server jin-tf2-00 is shown. The server name is shown at 1102 and the full game name is shown at 1104, which in the present case is “Team Fortress 2.” The computer address of the game is shown at 1106, which is 192.168.0.1.

Again referring to FIG. 11, at 1108, it provides information about the game. In this case, the class of the game is “FREE PROMO,” which means the system user can play for free without having to deposit any bitcoin on the game server. Other classes of gameplay are the following: LOW STAKES, AVERAGE STAKES, and HIGH STAKES. It is understood by a person of ordinary skill in the art that other than these classes may be defined and it would still be within the scope of the present invention. With regard to competitive gameplay, at 1108, it indicates that for each “Kill” the system user will receive +0.98 Satoshi and −1 Satoshi for each time the system user dies in the game. The minimum number of Satoshi for playing the game is 10. At 1114, it shows that a maximum of 100 players are allowable to play the game, there are no active players at this time.

At 1110, the display screen in FIG. 11 provides information that the system user should review. The indication that the system user is “already connected to Steam” means that the system user is connected to the control entity for access to the game Team Fortress 2. This type of connection may or may not be required with other games.

At 1112 in FIG. 11, it indicates the server balance of “0” Satoshi with respect to the game. Since neg0 has not provided any Satoshi to be held to play the game, the Satoshi value will be “0.” However, once neg0 holds an amount of Satoshi for gameplay, this value will be change commensurate with the amount of Satoshi that is held for the game.

At 1118 of FIG. 11, it provides information about the top players with respect to the game. The information provided is the rank of the players, each of their ratings, their name, and when each was last online. For purposes of information about each of the top players, the rating refers to how well a system user plays on that game server compared to other system users on that game server. It would be understood by a person of ordinary skill in the art that other information about top players could be provided and it would still be within the scope of the present invention.

FIG. 11 also has information for assisting the system user in the use of the present invention. As shown at 1120, there are icons for Play, Guide, Forum, and Chat. These icons when activated will assist the system user in understanding gameplay and an ability to speak with others about the game. Further, at 1122, the system user's current Bitcoin account balance is shown.

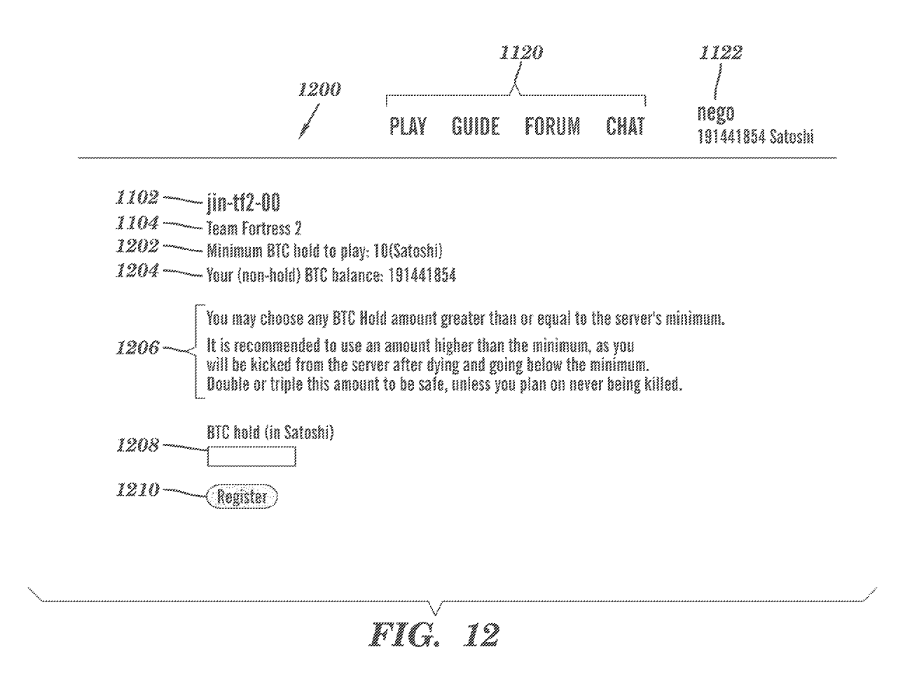

If after reviewing all the information in FIG. 11, the system user desires to register to play the game, that system user will activate register icon 1124. This will cause the screen display at FIG. 12 to be opened.

Referring to FIG. 12, generally at 1200, the API server 214 registering screen is shown. The information at 1102, 1104, 1120, and 1122, is the same as is shown in FIG. 11 and the descriptions associated with those reference numbers are incorporated here by reference.

At 1202 in FIG. 12, it indicates the minimum number of bitcoin that has to be held in order for the system user to register. At 1204, it shows the non-held amount of bitcoin in the system user's Bitcoin account. To the extent that the system user holds a certain amount of bitcoin to play the game on the current server, it will reduce the amount of non-held bitcoin in the system user's Bitcoin account balance if the system user loses that amount in gameplay.

At 1206, there is information provided to the system user about the amount of bitcoin that should be held for the game.

In entering the amount to be held at 1208, the system user will consider the recommendations provided in the information at 1206.

Once the system user has entered the bitcoin hold amount at 1208, he/she will activate register icon 1210 which will register that system user for gameplay. If that system user is the first active player, it would change the value at 1114 in FIG. 11 to read “1/100.” Further, registering for the game will be shown as a transaction on the Transactions display screen shown in FIG. 7.

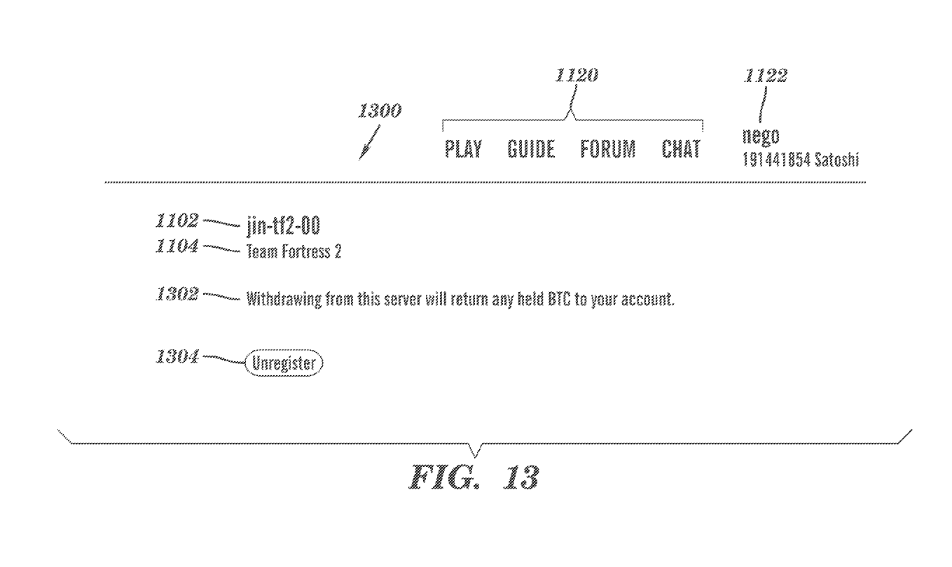

FIG. 13, generally at 1300, shows the display screen that the system user will use to unregister from a game server. The information at 1102, 1104, 1120, at 1122 is the same as is shown in FIG. 11 and the descriptions associated with those reference numbers are incorporated here by reference.

Again referring to FIG. 13, at 1302, it indicates that when the system user withdraws from the game server, the held Bitcoin will be returned to the system user's Bitcoin account. So, when the system user has participated the gameplay to the point that he/she no longer wants to play, that system user will activate Unregister icon 1304, which will unregister him/her from the game. When this unregistering takes place, it will be shown as a transaction on the Transaction display screen shown in FIG. 7.

When a system user, such as neg0, wants to create a match for competitive gameplay with other system users in which wins and losses will be transacted in Bitcoin, the system user will activate a Create a Match button on the screen display 1500.

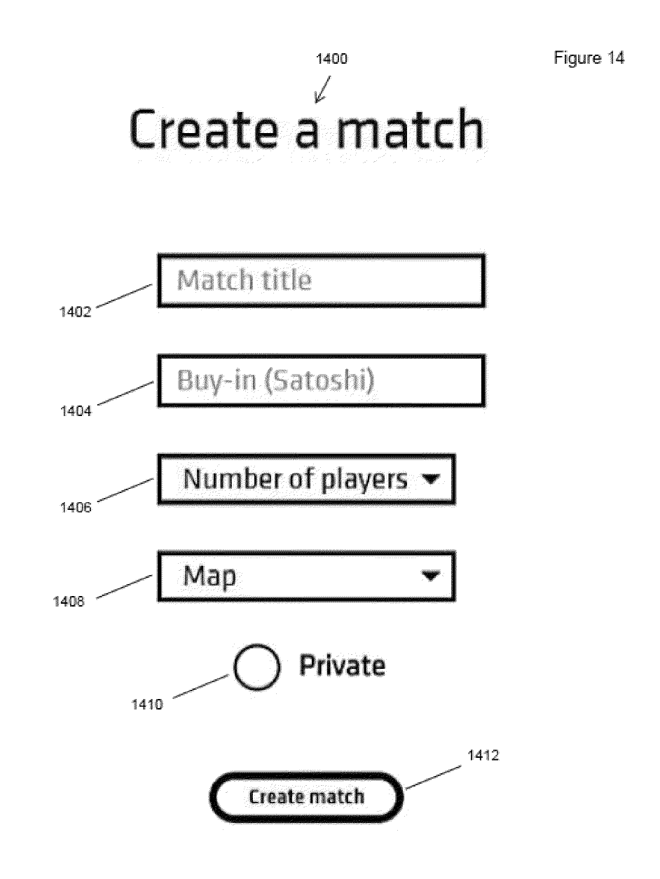

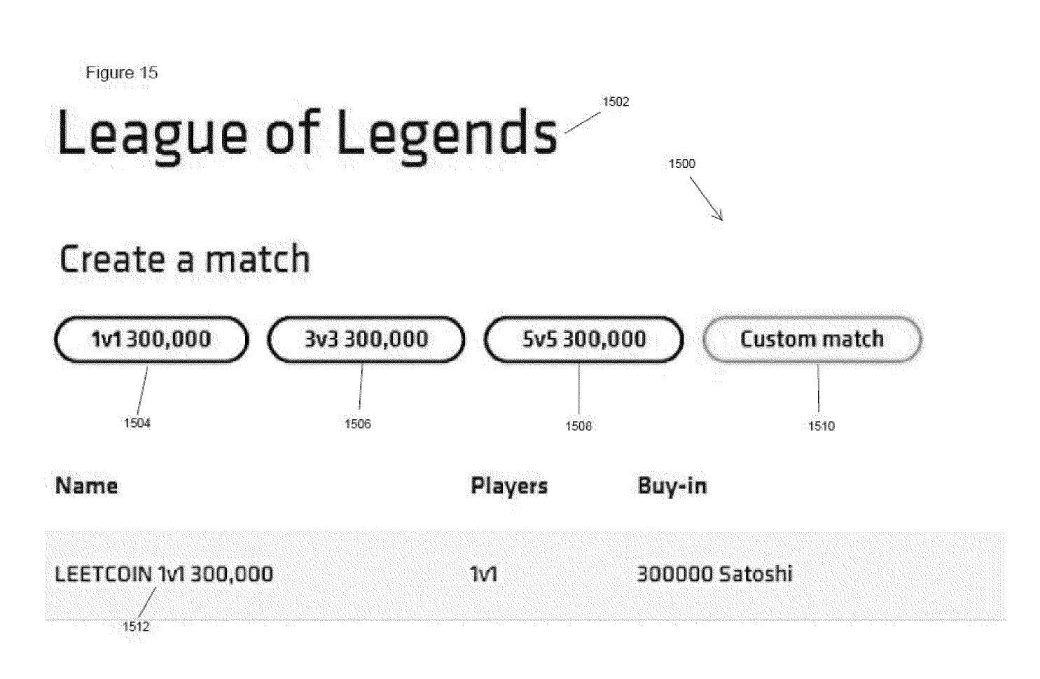

When Create a Match icon button is activated, it will open the display screen shown in FIG. 14, generally at 1400. The system user creating the match will enter the match title at 1402 and the buy-in amount of Satoshi at 1404. The system user will then add the number of players for the match at 1406. The information added at 1408 with respect to the “Map” includes a list of available maps for game play. If the system user wishes to restrict the gameplay to only certain system users, the system user will indicate that by checking the Private button at 1410. This will cause the match to not be displayed on the match list page. The system users playing the match can share, for example, e.g., their URLs, with others to play the match. Once all the information is added, the system user will activate “Create match” icon 1412. This will open the screen display shown at FIG. 15. FIG. 15, generally at 1500, shows the match screen that is created from the information provided at FIG. 14.

Again referring to FIG. 15, the game that is to be played is indicated at 1502, which in this case is “League of Legends.” The “Create a Match” display screen provides icons for activation for a variety of preset matches. By way of example, the icons include 1v1 300,000 at 1504, 3v3 300,000 at 1506, 5v5 300,000 at 1508, and Custom Match at 1510. The first three icons, if activated, would provide matches based on what is shown; for example, “1v1” would a mean one-on-one competition and the buy-in is 300,000 Satoshi. If the Custom Match icon at 1510 is activated, the number of players and other match parameters would be added on a separate display screen. For example, 1v1, 2v2, 3v3, 4v4, 5v5, a custom Satoshi amount for which the match can be played, and the map on which a system user would like to play.

The information from FIG. 14 along with a possible selection from the icon shown at 1504, 1506, at 1508, generate the match shown at 1512, which has the name LEETCOIN 1v1 300,000, the “players” will be based on 1v1, and the buy-in would be 300000 Satoshi.

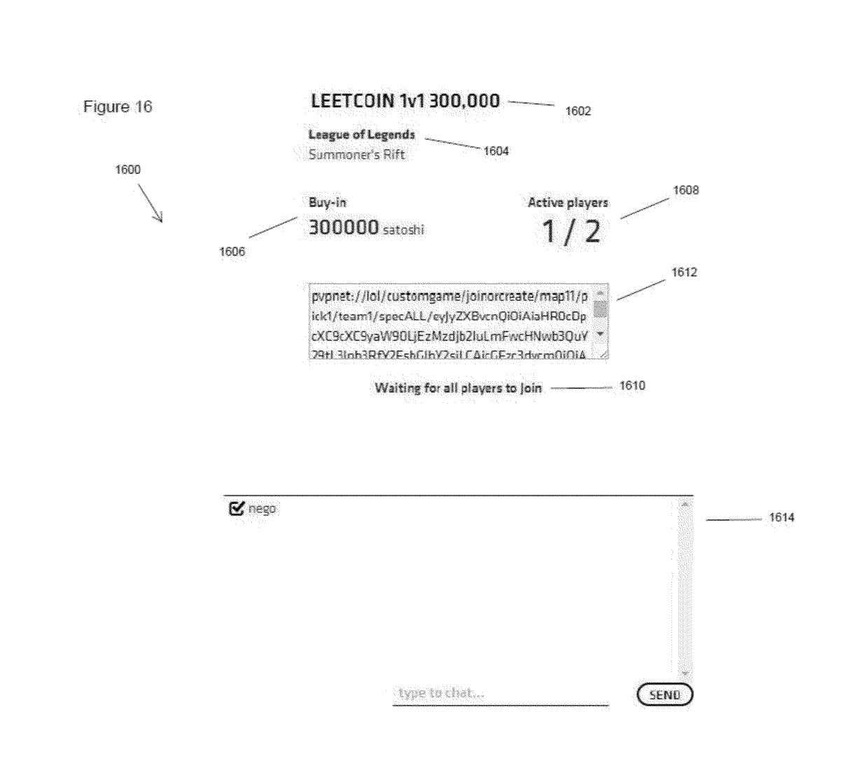

When the system user has completed the information shown at FIG. 15, he/she will activate the match view page, which will open the display screen shown at FIG. 16. Referring to FIG. 16, generally at 1600, information regarding the match that has been created is provided. The match name is shown at 1602, which is “Summoner's Rift: League of Legends,” and the amount for buy-in, 300,000 Satoshi, is shown at 1606. Since the match is meant to be 1v1, the number of active players that can participate is shown at 1608. At present, only one of the two players has actively registered into the match, so, at 1610, it indicates that the system is waiting for the remaining player to join before the match can begin. The window at 1612 provides the following information: the League of Legends tournament code. Finally, the window at 1614 is a discussion board for system users to chat with each other.

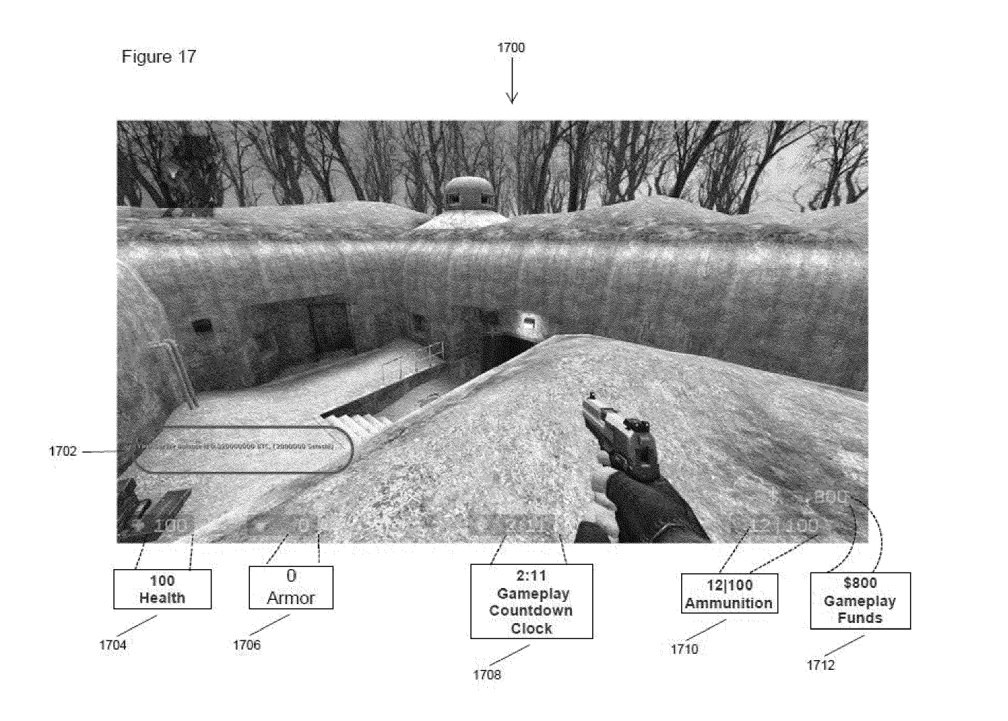

Now that the system the present invention has been described, an example of the operation of the system in which wins and losses are transacted in Bitcoin will be provided with respect to FIGS. 17-20 and the gameplay will relate to the game “Counter-Strike.”

As described previously, if the system user is a new user or first time user or not has it acquired bitcoin or seeks to learn more about the system and method of the present invention before entering gameplay to transact wins and losses in Bitcoin, that system user may connect through the API server of the present invention to promo game servers and play for free. This will permit such system users to gain experience and proficiency before taking any financial risk in competitive gameplay for bitcoins.

The promo and also low stakes game servers are designed for system users at all skill levels. Besides new and inexperienced system users using the promo and low stakes game servers, the promo and low stakes game servers can be used by the system users to practice or warm up before entering competitive gameplay for bitcoins.

When a system user desires to enter into competitive gameplay with other system users and transact wins and losses in Bitcoin, the system user will first logon to API server 214 using the system users ID, which will produce a screen display, such as that shown at a Profile page. From the screen display, the system user will select a promo server and register on the server, and then connect to the game server and play the game. Once the system user has gained some skill and proficiency in gameplay at the promo server level and wants to play for bitcoins based on wins and losses, the system user will logout of the promo server and again logon to the API server and select Deposit icon 616 on Profile display screen 600 in FIG. 6. The system user will enter the amount of bitcoins he/she desires to deposit for gameplay and register on the game server with the amount of bitcoins the system user is required to enter to qualify to play. The system user will then play the game. The results of gameplay will impact the amount of bitcoins the system user has provided to be held for such gameplay and, at the end of the game, this amount will be reflective of gameplay success.

The system and method of the present invention also provide that a system user's Bitcoin account balance may be positively affected by certain acts. For example, the system and method present invention may be set up so that if a system user shares his/her referral links with friends, such a system user may receive a predetermined number of bitcoin for each referral. Further, there can be a bonus in bitcoins for a system user being the most proficient and successful with respect to other system users in competitive gameplay.

Again referring to FIG. 17-20, an exemplary gameplay experience will be described in which wins and losses are transacted in Bitcoin. Referring to FIG. 17, generally at 1700, the beginning of gameplay is shown with respect to the game “Counter-Strike.” It would be understood by a person of ordinary skill in the art that other games could be played besides Counter-Strike and it would still be within the scope of the present invention.

As shown at 1702 in FIG. 17, at the beginning of gameplay, system user neg0 has a server balance of 0.020000000 BTC (2000000 Satoshi). Also shown with respect to the gameplay screen display are a 100% health value at 1704, a “0” Armor value at 1706, the gameplay countdown clock at 1708, an ammunition usage value at 1710, and a gameplay funds value of $800 at 1712. The gameplay funds value indicates the amount of funds the system user has available for gameplay. The gameplay funds value is shown in dollars; however, it may be shown in any currency value or in Satoshi and it will be within the scope of the present invention. The transactions between the system users may be displayed in bitcoin not dollars.

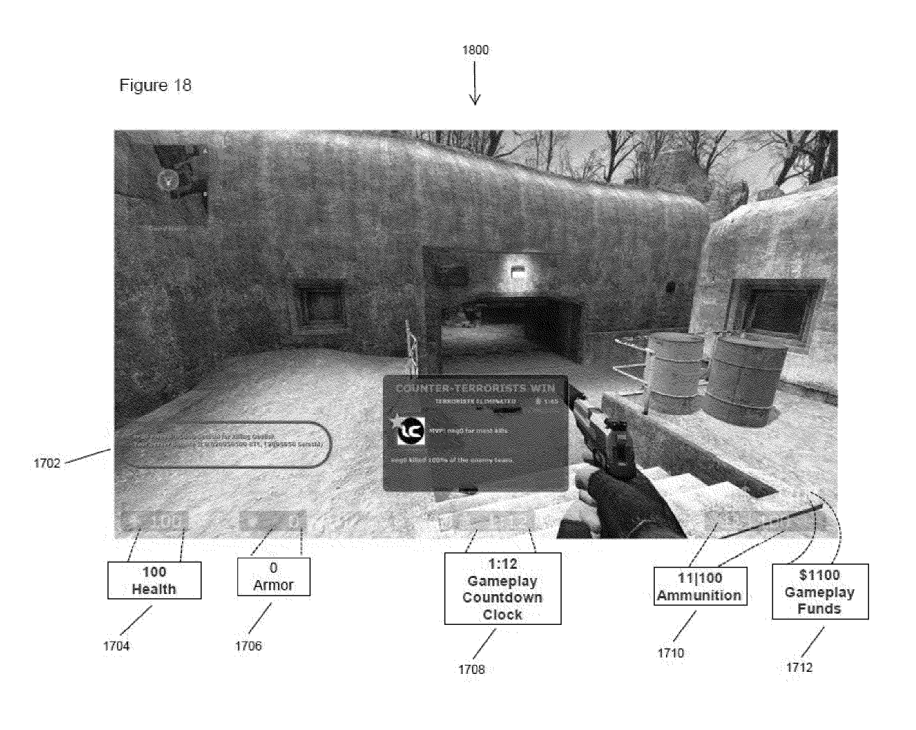

Referring to FIG. 18, generally at 1800, it shows that the system user neg0 is beginning to engage the opponent system user Obelisk. Since nothing has happened in gameplay up to this point, the only change in the gameplay information is that the countdown clock has counted down from 2 minutes 11 seconds to 1 minute 35 seconds. The descriptions relating to 1702, 1704, 1706, 1708, 1710, and 1712 are the same as they were for the same reference numerals in FIG. 17. As such, those descriptions are incorporated here by reference.

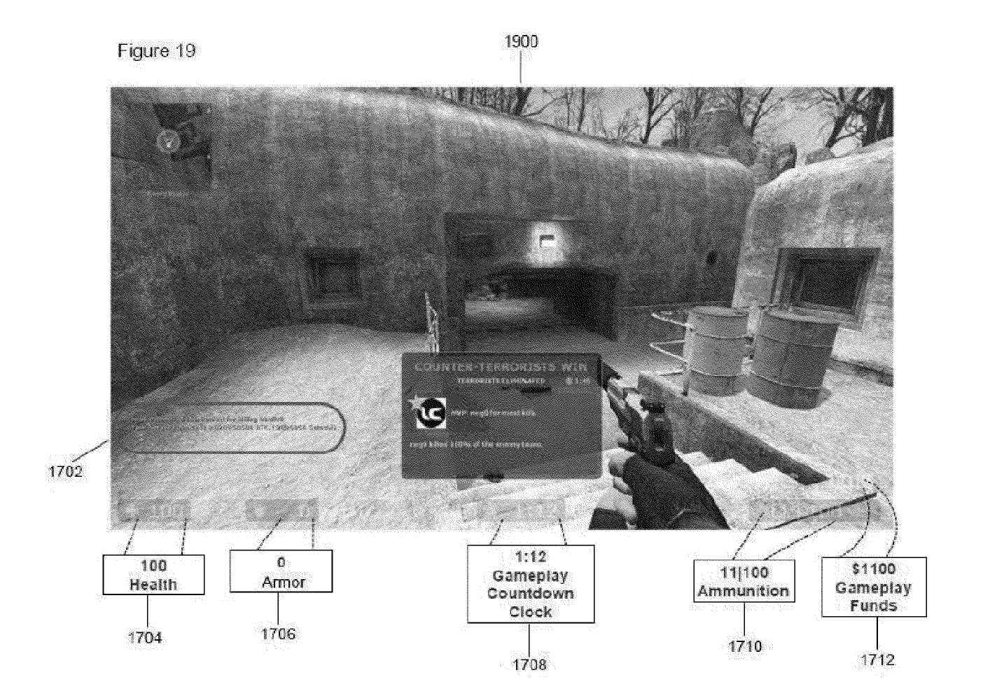

Referring to FIG. 19, generally at 1900, there is been interaction between the two opponents and system user neg0 has eliminated system user Obelisk. At 1702, this action is reflected in the change of the information provided at that location. The following is indicated at 1702:

neg0 earned: 95050 Satoshi for killing Obelisk

Your Server balance is 0.020950500 BTC, (2095050 Satoshi)

As shown, neg0's server balance has been increased by 95050 Satoshi. If Obelisk's server account balance was viewed, it would be decreased by this amount. Further, certain information associated with gameplay also has changed. The gameplay countdown clock at 1708 has counted down to 1 minute 12 seconds, the ammunition value has been reduced at 1710 and reflects a value of 11|100 down from 12|100. Finally, the gameplay funds amount based on the Obelisk kill has been increased from $800 to $1100 at 1712. The descriptions for 1704 and 1706 are the same as they were for the same reference numerals in FIG. 17. As such, those descriptions are incorporated here by reference. The dollar values are based on a consistent bitcoin value. If this Bitcoin value changes because of the Bitcoin market, the dollar values would also change.

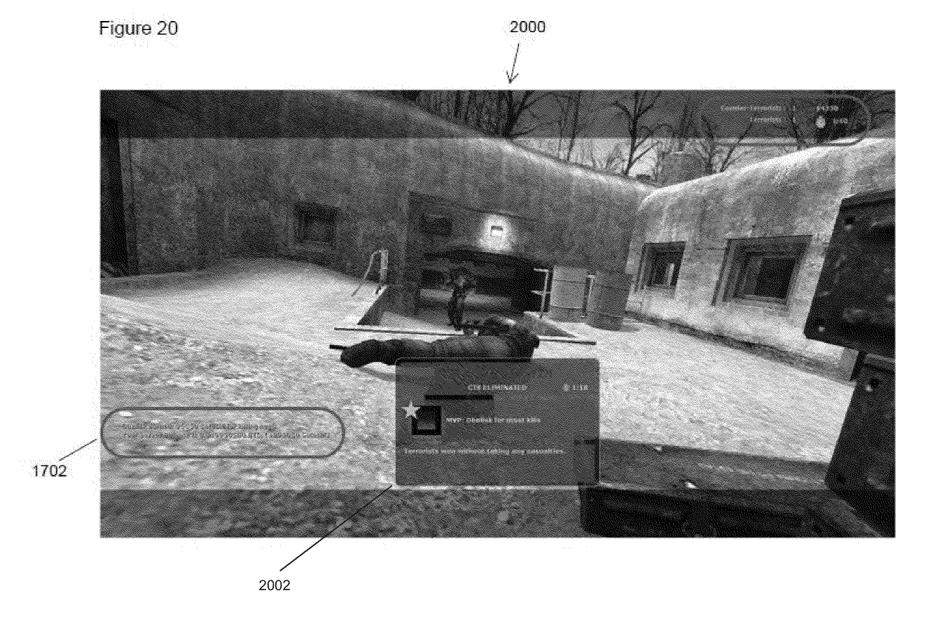

Referring to FIG. 20, generally at 2000, a screen display is shown after system user neg0 has been eliminated. When system user neg0 is eliminated, the current game ends and summary information regarding gameplay is shown at 2002. Here, it indicates that Counter-Terrorist 1 (system user neg0) and Terrorist 1 (system user Obelisk) have each won a round. It also shows that the server balance is $4350, which means the system user neg0 has this amount available to purchase in game items or use for other gameplay. The clock value of 1 minute 40 seconds means the round has this amount of time remaining until it is completed. As such, a new game can be commenced between system user neg0 and system user Obelisk.

Information about the Satoshi held by neg0 after being eliminated is shown at 1702. The following is a server balance for system user neg0 following elimination by system user Obelisk:

Obelisk earned: 95050 Satoshi for eliminating neg0

Your Server Balance is 0.019950500 BTC, (1995050 Satoshi)

Therefore, it is shown that the server balance for system user neg0 was reduced based on being eliminated by system user Obelisk. For purposes of the present example, the neg0's server balance in Satoshi prior to being eliminated by system user Obelisk was 2090100 Satoshi.

The example provided above is meant to be an illustration of the implementation of the system and method of the present invention being layered on top of a game server. However, a person of ordinary skill in the art would understand that other implementations and illustrations could be provided and it would still be within the scope of the present invention.

The embodiments or portions thereof of the system and method of the present invention may be implemented in computer hardware, firmware, and/or computer programs executing on programmable computers or servers that each includes a processor and a storage medium readable by the processor (including volatile and non-volatile memory and/or storage elements). Any computer program may be implemented in a high-level procedural or object-oriented programming language to communicate within and outside of computer-based systems.

Any computer program may be stored on an article of manufacture, such as a storage medium (e.g., CD-ROM, hard disk, or magnetic diskette) or device (e.g., computer peripheral), that is readable by a general or special purpose programmable computer for configuring and operating the computer when the storage medium or device is read by the computer to perform the functions of the embodiments. The embodiments, or portions thereof, may also be implemented as a machine-readable storage medium, configured with a computer program, where, upon execution, instructions in the computer program cause a machine to operate to perform the functions of the embodiments described above.

The embodiments, or portions thereof, of the system and method of the present invention described above may be used in a variety of applications. Although the embodiments, or portions thereof, are not limited in this respect, the embodiments, or portions thereof, may be implemented with memory devices in microcontrollers, general purpose microprocessors, digital signal processors (DSPs), reduced instruction-set computing (RISC), and complex instruction-set computing (CISC), among other electronic components. Moreover, the embodiments, or portions thereof, described above may also be implemented using integrated circuit blocks referred to as main memory, cache memory, or other types of memory that store electronic instructions to be executed by a microprocessor or store data that may be used in arithmetic operations.

The descriptions are applicable in any computing or processing environment. The embodiments, or portions thereof, may be implemented in hardware, software, or a combination of the two. For example, the embodiments, or portions thereof, may be implemented using circuitry, such as one or more of programmable logic (e.g., an ASIC), logic gates, a processor, and a memory.

While various embodiments have been described above, it should be understood that they have been presented by way of example only, and not limitation. For instance, advertisements may be placed with groups of objects, rather than individual objects, and still be within the scope of the present invention. As such, the breadth and scope of the preferred embodiments should not be limited by any of the above-described exemplary embodiments. Further, various modifications to the disclosed embodiments will be apparent to those skilled in the art, and the general principals set forth below may be applied to other embodiments and applications. Thus, the present invention is not intended to be limited to the embodiments shown or described herein.

1. A computer-implemented system for conducting competitive gameplay between at least two system users in which wins and losses are transacted using crypto-currency, comprising:
at least a first system user input device controlled by first system user and a second system user input device controlled by a second system user, with the first and second system user input devices each being capable of providing the first and second system users, respectively, access for input to the computer-implemented system for set up and conducting competitive gameplay in which wins and losses are transacted using a crypto-currency, and with the first and second system user input devices being capable of displaying gameplay and displaying the results of gameplay including the resulting crypto-currency account balances for each of the first and second system user input devices;
a wireless network that is electronically connected to the at least first and second system user input devices and at least one application programming interface (“API”) server, with the wireless network being capable of receiving and transmitting electronic transmissions from and to, respectively, the at least first and second system user input devices and receiving and transmitting electronic transmissions from and to, respectively, at least one application programming interface (“API”) server;
the API server that is electronically connected to the wireless network and at least one game server, with the API server receiving requests from the at least first and second system user devices for the at least first and second user input devices to engage in competitive gameplay, managing crypto-currency accounts for the at least first and second system user input devices, receiving crypto-currency amounts from the at least first and second system user input devices and depositing the crypto-currency received in the crypto-currency account associated with the at least first and second system user input devices, holding a predetermined portion of the crypto-currency in the respective crypto-currency account of the at least first and second system user input devices to meet at least a minimum crypto-currency value for each of the at least first and second system user devices to participate in gameplay, calculating crypto-currency account balances for each of the at least first and second system user input devices according to at least wins and losses in gameplay received electronically from the game server, withdrawing crypto-currency from the at least first or second system user input device crypto-currency account according to an electronic request transmitted from such system user input device, controlling the at least first and second system user input devices logging onto and logging off of the game server for gameplay, reporting to the first system user input device for display thereon the crypto-currency account balance for the first system user input device during and at the end of gameplay according to wins and losses during gameplay, and reporting to the second system user input device for display thereon the crypto-currency account balance for the second system user input device during and at the end of the gameplay according to wins and losses during gameplay; and
the game server that is electronically connected to the API server, with the game server receiving electronic instructions from the API server naming system user input devices authorized to participate in gameplay on the game server, conducting competitive gameplay according to predetermined rules of a game stored on the game server, storing and periodically transmitting electronically to the API server wins and losses by each system user input devices, logging in and logging out the system user input devices according to instructions electronically received from the API server.

2. The system as recited in claim 1, wherein the system input devices include a smart phone, tablet device, personal digital assistant (“PDA”), a laptop computer, or a desktop computer.

3. The system as recited in claim 1, wherein the crypto-currency includes Bitcoin.

4. The system as recited in claim 1, the API server includes at least a CPU, internal memory, and input/output (“I/O”) system, and electronic connections between the CPU, internal memory, and I/O system.

5. The system as recited in claim 1, the game server includes at least a CPU, internal memory, and input/output (“I/O”) system, and electronic connections between the CPU, internal memory, and I/O system.

6. The system as recited in claim 1, wherein the API server sets a crypto-currency value for wins and a crypto-currency value for losses for calculating crypto-currency account balances for the at least first and second system user input devices according to wins and losses in competitive gameplay on the game server.

7. The system as recited in claim 1, wherein more than two system user input devices include being electronically connected to the API server through the wireless network.

8. The system as recited in claim 7, wherein the more than two system user input devices compete competitively in gameplay and wins and losses are transacted in crypto-currency.

9. The system as recited in claim 8, wherein the more than two system user input devices are divided into teams to competitively compete in gameplay and wins and losses are transacted in crypto-currency.

10. The system as recited in claim 1, wherein the wireless network includes the Internet.

11. A computer-implemented method for conducting competitive gameplay between at least two system users in which wins and losses are transacted using crypto-currency, comprising the steps of:
(A) at least a first system user input device controlled by first system user and a second system user input device controlled by a second system user being electronically connected to a API server through a wireless network for setting up and conducting competitive gameplay in which wins and losses are transacted using a crypto-currency;
(B) at least the first system user input device and the second input user device each creating a crypto-currency account on the API server and each system user input device depositing an amount crypto currency in the crypto-currency account;
(C) the at least first and second system user input devices electronically transmitting instructions to the API server to hold a portion of the amount deposited in that system user input device's crypto-currency account at or above a minimum amount for each system user input device to be authorized to engage in gameplay on a game server;
(D) the API server electronically transmitting to the game server a list of system user input devices authorized to engage in gameplay on the game server according to the amount held at step (C);
(E) the at least first and second system user devices logging onto the game server through the API server to engage in competitive gameplay in which wins and losses are transacted using crypto-currency;
(F) the at least first and second system user devices engaging in competitive gameplay on the game server with the game server storing and periodically transmitting to the API server the wins and losses of the at least first and second system user devices engaged in competitive gameplay;
(G) the API server calculating changes in crypto-currency account balances for the at least first and second system user devices according to the wins and losses of the at least first and second system user devices in competitive gameplay and periodically reporting changes in the crypto-currency account balances respectively to the first and second system user input devices;
(H) at the end of competitive gameplay, the at least first and second system user devices logging off of the game server through the API server with the at least first and second system user devices having their crypto-currency account balance in their crypto currency being changed positively if the number of wins exceeded the number of losses in gameplay or negatively if the number of losses exceeded the number of wins;
(I) the first system user input device displaying gameplay and displaying results of gameplay including changes in the crypto-currency account balance for first system user input device according to wins and losses experienced in gameplay reported by the game server to the API server and calculated by the API server and reported to the first system user input device for display; and
(J) the second system user input device displaying gameplay and displaying results of gameplay including changes in the crypto-currency account balance for second system user input device according to wins and losses experienced in gameplay reported by the game server to the API server and calculated by the API server and reported to the second system user input device for display.

12. The method as recited in claim 11, wherein the crypto-currency includes Bitcoin.

13. The method as recited in claim 11, wherein the system input devices include a smart phone, tablet device, personal digital assistant (“PDA”), a laptop computer, or a desktop computer.

14. The method as recited in claim 11, the API server includes at least a CPU, internal memory, and input/output (“I/O”) system, and electronic connections between the CPU, internal memory, and I/O system.

15. The method as recited in claim 11, the game server includes at least a CPU, internal memory, and input/output (“I/O”) system, and electronic connections between the CPU, internal memory, and I/O system.

16. The method as recited in claim 11, wherein the API server sets a crypto-currency value for wins and a crypto-currency value for losses for calculating system user crypto-currency account balances according to wins and losses in competitive gameplay on the game server.

17. The method as recited in claim 11, wherein the wireless network includes the Internet.
